(19) United States
(12) Patent Application Publication
(10) Pub. No.: US 2023/0013007 A1
(43) Pub. Date: Jan. 19, 2023

(54) MOVING BODY CONTROL SYSTEM, MOVING BODY CONTROL METHOD, AND MOVING BODY REMOTE SUPPORT SYSTEM

(71) Applicant: Woven Planet Holdings, Inc., Tokyo (JP)

(72) Inventor: Toshinobu WATANABE, Tokyo-to (JP)

(73) Assignee: Woven Planet Holdings, Inc., Tokyo (JP)

(21) Appl. No.: 17/857,434

(22) Filed: Jul. 5, 2022

(30) Foreign Application Priority Data
Jul. 19, 2021 (JP) 2021-118895

(51) Int. Cl. H04N 7/18; G06V 20/56; G06T 7/11; G06T 7/70; G05D 1/00

(52) U.S. Cl. CPC H04N 7/185; G06V 20/56; G06T 7/11; G06T 7/70; G05D 1/0038; H04L 67/12

(57) ABSTRACT

A moving body control system controls a moving body being a target of remote support by a remote operator. The moving body control system acquires an image captured by a camera installed on the moving body, and spatially splits the image into a plurality of split images. The moving body control system sets importance of each of the plurality of split images such that the importance of a split image with a higher need for gaze by the remote operator is higher than the importance of a split image with a lower need for the gaze by the remote operator. The moving body control system encodes and transmits each split image to a remote support device on the remote operator side such that an image quality of the split image of the higher importance is higher than an image quality of the split image of the lower importance.

### CROSS-REFERENCE TO RELATED APPLICATION

This application claims priority to Japanese Patent Application No. 2021-118895 filed on Jul. 19, 2021, the entire contents of which are incorporated by reference herein.

### BACKGROUND

### Technical Field

The present disclosure relates to a technique for transmitting an image from a moving body being a target of remote support to a remote support device.

### Background Art

Patent Literature 1 discloses a video data transmission system including a transmitting device and a receiving device. The transmitting device transmits data of each frame constituting the video to a transmission path. At this time, the transmitting device decimates a specific frame in accordance with a predetermined rule. The receiving device includes a frame interpolation means. The frame interpolation means outputs an interpolated frame data at a timing of the decimated specific frame.

Patent Literature 2 discloses an image transmission device including a first device on a transmitting side and a second device on a receiving side. The first device acquires an image of a human face and the like captured by a video camera, and transmits the image to the second device. The second device displays the image received from the first device on a display device. In addition, the second device acquires a coordinate specified by an operator or a coordinate of an eye direction of the operator, which is the coordinate on a display screen, and transmits the coordinate information to the first device. The first device transmits the image with setting an image quality of a gaze region including the coordinate indicated by the coordinate information high.

### LIST OF RELATED ART

Patent Literature 1: Japanese Laid-Open Patent Application Publication No. JP-2008-252333

Patent Literature 2: Japanese Laid-Open Patent Application Publication No. JP-H10-112856

### SUMMARY

A situation in which a remote operator remotely supports an operation of a moving body such as a vehicle and a robot is considered. An image captured by a camera installed on the moving body is transmitted from the moving body to a remote support device on the side of the remote operator. The remote operator performs remote support for the moving body by referring to the image transmitted from the moving body. Here, a delay of the image transmission from the moving body to the remote support device causes a decrease in accuracy of the remote support. Although it is desirable to reduce the delay of the image transmission, decimating the frame on the transmitting side as disclosed in the above-mentioned Patent Literature 1 causes a decrease in image quality. The decrease in the image quality results in decrease in the accuracy of the remote support after all.

An object of the present disclosure is to provide a technique capable of reducing a delay while securing a image quality when transmitting an image from a moving body being a target of remote support to a remote support device.

A first aspect is directed to a moving body control system that controls a moving body being a target of remote support by a remote operator.

The moving body control system includes one or more processors.

The one or more processors are configured to:

acquire an image captured by a camera installed on the moving body and indicating a situation around the moving body;

execute an image splitting process that spatially splits the image into a plurality of split images;

execute an importance setting process that sets importance of each of the plurality of split images such that the importance of a split image with a higher need for gaze by the remote operator is higher than the importance of a split image with a lower need for the gaze by the remote operator; and

execute a split transmitting process that encodes and transmits each of the plurality of split images to a remote support device on a side of the remote operator such that an image quality of the split image of the higher importance is higher than an image quality of the split image of the lower importance.

A second aspect is directed to a moving body control method that controls a moving body being a target of remote support by a remote operator.

The moving body control method includes:

acquiring an image captured by a camera installed on the moving body and indicating a situation around the moving body;

an image splitting process that spatially splits the image into a plurality of split images;

an importance setting process that sets importance of each of the plurality of split images such that the importance of a split image with a higher need for gaze by the remote operator is higher than the importance of a split image with a lower need for the gaze by the remote operator; and

a split transmitting process that encodes and transmits each of the plurality of split images to a remote support device on a side of the remote operator such that an image quality of the split image of the higher importance is higher than an image quality of the split image of the lower importance.

A third aspect is directed to a moving body remote support system.

The moving body remote support system includes:

a moving body being a target of remote support by a remote operator; and

a remote support device on a side of the remote operator.

The moving body is configured to:

acquire an image captured by a camera installed on the moving body and indicating a situation around the moving body;

execute an image splitting process that spatially splits the image into a plurality of split images;

execute an importance setting process that sets importance of each of the plurality of split images such that the importance of a split image with a higher need for gaze by the remote operator is higher than the importance of a split image with a lower need for the gaze by the remote operator; and

execute a split transmitting process that encodes and transmits each of the plurality of split images to the remote support device such that an image quality of the split image of the higher importance is higher than an image quality of the split image of the lower importance.

According to the present disclosure, the image captured by the camera installed on the moving body is split into the plurality of split images. Furthermore, the importance of each of the plurality of split images is set. More specifically, the importance of a split image with a higher need for gaze by the remote operator is set to be higher than the importance of a split image with a lower need for gaze. Then, each split image is encoded and transmitted such that the image quality of the split image of the higher importance is higher than the image quality of the split image of the lower importance.

While the image quality of the split image of the higher importance is set higher, the image quality of the split image of the lower importance is set lower. It is thus possible to reduce a data transmission amount as a whole while securing the image quality of the important part. Since the data transmission amount is reduced, the delay of the image transmission is suppressed. That is, it is possible to reduce the delay of the image transmission while securing the image quality of the important part. As a result, the accuracy of the remote support is improved. In addition, since the data transmission amount is reduced, a communication cost is also reduced.

### BRIEF DESCRIPTION OF DRAWINGS

FIG. 1 is a conceptual diagram showing a vehicle remote support system according to an embodiment of the present disclosure;

FIG. 2 is a conceptual diagram for explaining an outline of remote support according to an embodiment of the present disclosure;

FIG. 3 is a block diagram showing a configuration example of a vehicle control system according to an embodiment of the present disclosure;

FIG. 4 is a block diagram showing an example of driving environment information according to an embodiment of the present disclosure;

FIG. 5 is a block diagram showing a configuration example of a remote support device according to an embodiment of the present disclosure;

FIG. 6 is a conceptual diagram for explaining an outline of split image transmission according to an embodiment of the present disclosure;

FIG. 7 is a conceptual diagram showing an example of setting of importance of split images according to an embodiment of the present disclosure;

FIG. 8 is a block diagram showing an example of a functional configuration of a vehicle control system related to split image quality control according to an embodiment of the present disclosure;

FIG. 9 is a conceptual diagram for explaining a first example of an importance setting process according to an embodiment of the present disclosure;

FIG. 10 is a conceptual diagram for explaining a second example of an importance setting process according to an embodiment of the present disclosure;

FIG. 11 is a conceptual diagram for explaining a third example of an importance setting process according to an embodiment of the present disclosure;

FIG. 12 is a conceptual diagram for explaining a fourth example of an importance setting process according to an embodiment of the present disclosure;

FIG. 13 is a block diagram for explaining a fifth example of an importance setting process according to an embodiment of the present disclosure;

FIG. 14 is a timing chart for explaining an example of split image parallel processing according to an embodiment of the present disclosure;

FIG. 15 is a timing chart for explaining another example of split image parallel processing according to an embodiment of the present disclosure;

FIG. 16 is a block diagram showing an example of a functional configuration of a vehicle control system related to split image parallel processing according to an embodiment of the present disclosure;

FIG. 17 is a block diagram showing an example of a functional configuration of a remote support device related to split image parallel processing according to an embodiment of the present disclosure;

FIG. 18 is a block diagram showing another example of a functional configuration of a remote support device related to split image parallel processing according to an embodiment of the present disclosure;

FIG. 19 is a block diagram showing still another example of a functional configuration of a remote support device related to split image parallel processing according to an embodiment of the present disclosure;

FIG. 20 is a timing chart for explaining a comparative example of split image parallel processing according to an embodiment of the present disclosure;

FIG. 21 is a timing chart for explaining still another example of split image parallel processing according to an embodiment of the present disclosure;

FIG. 22 is a timing chart for explaining still another example of split image parallel processing according to an embodiment of the present disclosure; and

FIG. 23 is a block diagram showing still another example of a functional configuration of a vehicle control system according to an embodiment of the present disclosure.

### EMBODIMENTS

Embodiments of the present disclosure will be described with reference to the accompanying drawings.

### 1. Outline of Remote Support

In the present disclosure, “remote support” that remotely supports an operation of a moving body is considered. Examples of the moving body include a vehicle, a robot, a flying object, and the like. Examples of the robot include a logistics robot, a work robot, and the like. Examples of the flying object include an airplane, a drone, and the like. As an example, a case where the moving body is a vehicle is considered hereinafter. When generalizing, “vehicle” in the following description shall be deemed. to be replaced with “moving body.”

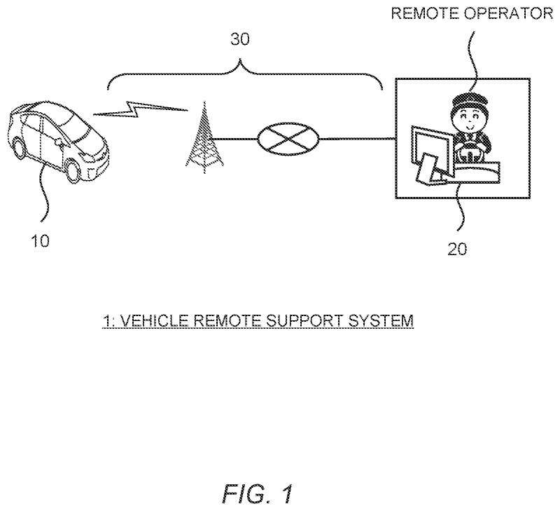

FIG. 1 is a conceptual diagram showing a vehicle remote support system 1 according to the present embodiment. The vehicle remote support system 1 includes a vehicle 10, a remote support device 20, and a communication network 30.

The vehicle 10 is, for example, a vehicle capable of automated driving. The automated driving supposed here is one where a driver may not necessarily 100% concentrate on the driving (e.g., so-called Level 3 or higher level automated driving). The vehicle 10 may be an automated driving vehicle of Level 4 or higher that does not need a driver. As another example, the vehicle 10 may be a vehicle manually driven by a driver. The vehicle 10 is a target of the remote support in the present embodiment.

The remote support device 20 is a device operated by a remote operator for performing the remote support for the vehicle 10. The vehicle 10 and the remote support device 20 are so connected as to be able to communicate with each other via the communication network 30. The remote support device 20 communicates with the vehicle 10 via the communication network 30 to remotely support travel of the vehicle 10. More specifically, the remote operator operates the remote support device 20 to remotely support the travel of the vehicle 10. It can be said that the remote support device 20 is a device for assisting the remote operator in performing the remote support for the vehicle 10.

The communication network 30 includes a wireless base station, a wireless communication network, a wire communication network, and the like. Examples of the wireless communication network include a 5G network.

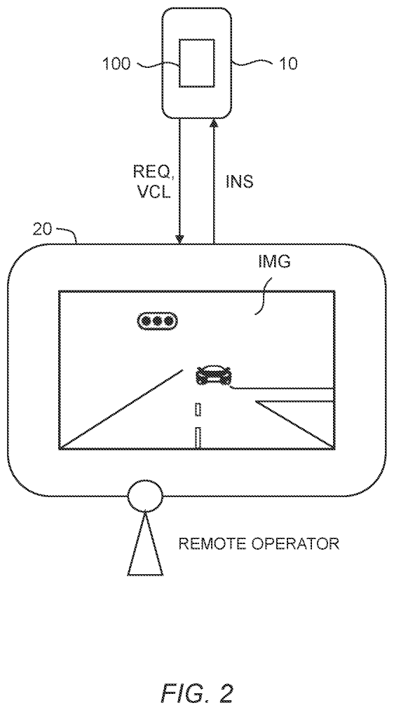

FIG. 2 is a conceptual diagram for explaining an outline of the remote support according to the present embodiment. A vehicle control system 100 controls the vehicle 10. For example, the vehicle control system 100 controls the automated driving of the vehicle 10. During the automated driving, the vehicle control system 100 recognizes a situation around the vehicle 10 by using a recognition sensor. Moreover, the vehicle control system 100 decides an action based on a result of the recognition process. Examples of the action include start, stop, right turn, left turn, lane change, and the like. Furthermore, the vehicle control system 100 decides an execution timing of the above action.

Typically, a situation where the remote support by the remote operator is necessary is a situation where the automated driving is difficult. For example, when at least one of the above-described recognition process, action decision process, and timing decision process is difficult to perform, the vehicle control system 100 requires the remote support for the difficult process. The vehicle control system 100 may request the remote operator to perform remote driving (remote operation) of the vehicle 10. The “remote support” in the present embodiment is a concept including not only support for at least one of the recognition process, the action decision process, and the timing decision process but also the remote driving (remote operation).

When determining that the remote support is necessary, the vehicle control system 100 transmits a remote support request REQ to the remote support device 20 via the communication network 30. The remote support request REQ is information for requesting the remote operator to perform the remote support for the vehicle 10. The remote support device 20 notifies the remote operator of the received remote support request REQ. In response to the remote support request REQ, the remote operator initiates the remote support for the vehicle 10.

During the remote support, the vehicle control system 100 transmits vehicle information VCL to the remote support device 20 via the communication network 30. The vehicle information VCL indicates a state of the vehicle 10, a surrounding situation, a result of processing by the vehicle control system 100, and the like. The remote support device 20 presents the vehicle information VCL received from the vehicle control system 100 to the remote operator.

In particular, the vehicle information VCL includes an image IMG captured by a camera installed on the vehicle 10. The image IMG represents a situation around the vehicle 10. The image IMG changes from moment to moment and changes in conjunction with movement of the vehicle 10 which is the target of the remote support. The vehicle control system 100 transmits such the image IMG to the remote support device 20 via the communication network 30. The remote support device 20 displays the image IMG received from the vehicle 10 on a display device.

The remote operator performs the remote support for the vehicle 10 by referring to the vehicle information VCL (especially the image IMG). An operator instruction INS is an instruction to the vehicle 10 and is input by the remote operator. The remote support device 20 receives the operator instruction INS input by the remote operator. Then, the remote support device 20 transmits the operator instruction INS to the vehicle 10 via the communication network 30. The vehicle control system 100 receives the operator instruction INS from the remote support device 20 and controls the vehicle 10 in accordance with the received operator instruction INS.

### 2. Example of Vehicle Control System

### 2-1. Configuration Example

The vehicle control system 100 controls the vehicle 10. Typically, the vehicle control system 100 is installed on the vehicle 10. Alternatively, at least a part of the vehicle control system 100 may be placed in an external device external to the vehicle 10 and remotely control the vehicle 10. That is, the vehicle control system 100 may be distributed in the vehicle 10 and the external device.

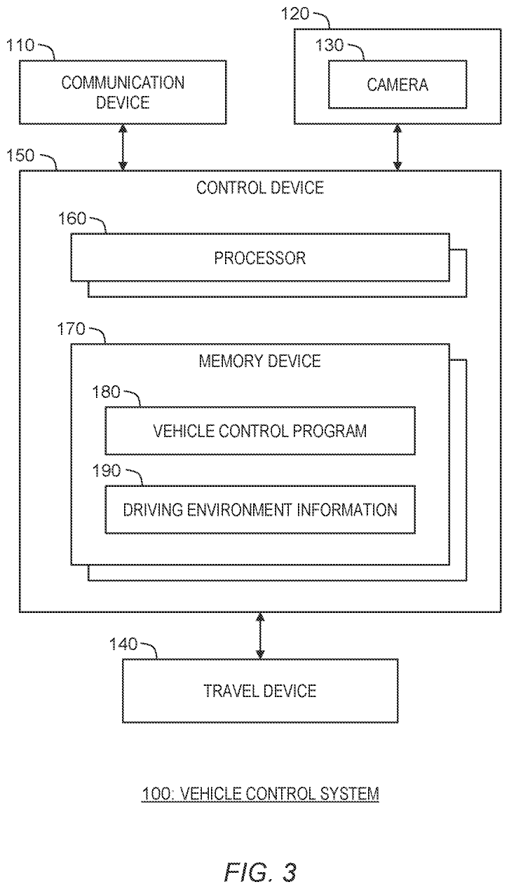

FIG. 3 is a block diagram showing a configuration example of the vehicle control system 100 according to the present embodiment. The vehicle control system 100 includes a communication device 110, a sensor group 120, a travel device 140, and a control device 150.

The communication device 110 communicates with the outside of the vehicle 10. For example, the communication device 110 communicates with the remote support device 20 via the communication network 30 (see FIGS. 1 and 2). The communication device 110 may support multiple types of communication methods (communication systems, communication protocols). Examples of the communication method include a common cellular method provided by MNO (Mobile Network Operator), an inexpensive cellular method provided by MVNO (Mobile Virtual Network Operator), a wireless LAN (Local Area Network) method, and the like.

The sensor group 120 is installed on the vehicle 10. The sensor group 120 includes a recognition sensor that recognizes a situation around the vehicle 10. The recognition sensor includes one or more cameras 130. The recognition sensor may further include a LIDAR (Laser Imaging Detection and Ranging), a radar, and the like. The sensor group 120 further includes a vehicle state sensor and a position sensor. The vehicle state sensor detects a state of the vehicle 10. Examples of the vehicle state sensor include a vehicle speed sensor, a yaw rate sensor, a lateral acceleration sensor, a steering angle sensor, and the like. The position sensor detects a position and an orientation of the vehicle 10. The position sensor is exemplified by a GPS (Global Positioning System) sensor.

The travel device 140 is installed on the vehicle 10. The travel device 140 includes a steering device, a driving device, and a braking device. The steering device turns wheels. For example, the steering device includes an electric power steering (EPS) device. The driving device is a power source that generates a driving force. Examples of the drive device include an engine, an electric motor, an in-wheel motor, and the like. The braking device generates a braking force.

The control device (controller) 150 controls the vehicle 10. The control device 150 includes one or more processors 160 (hereinafter simply referred to as a processor 160) and one or more memory devices 170 (hereinafter simply referred to as a memory device 170). The processor 160 executes a variety of processing. For example, the processor 160 includes a CPU (Central Processing Unit). The memory device 170 stores a variety of information necessary for the processing by the processor 160. Examples of the memory device 170 include a volatile memory, a non-volatile memory, an HDD (Hard Disk Drive), an SSD (Solid State Drive), and the like. The control device 150 may include one or more ECUs (Electronic Control Units). A part of the control device 150 may be an information processing device external to the vehicle 10.

A vehicle control program 180 is a computer program for controlling the vehicle 10. The functions of the control device 150 are implemented by the processor 160 executing the vehicle control program 180. The vehicle control program 180 is stored in the memory device 170. The vehicle control program 180 may be recorded on a non-transitory computer-readable recording medium.

### 2-2. Driving Environment Information

Driving environment information 190 indicates a driving environment for the vehicle 10. The driving environment information 190 is stored in the memory device 170.

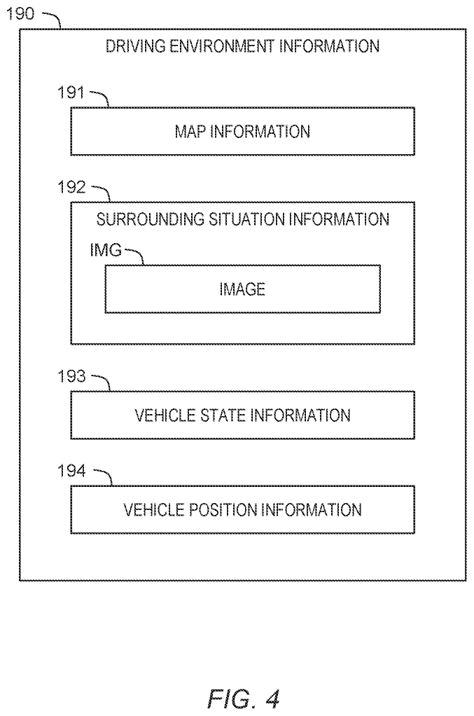

FIG. 4 is a block diagram showing an example of the driving environment information 190. The driving environment information 190 includes map information 191, surrounding situation information 192, vehicle state information 193, vehicle position information 194, and the like.

The map information 191 includes a general navigation map. The map information 191 may indicate a lane configuration, a road shape, and the like. The map information 191 may include position information of signals, signs, and the like. The processor 160 acquires the map information 191 of a necessary area from a map database. The map database may be stored in a predetermined storage device installed on the vehicle 10, or may be stored in a management server external to the vehicle 10. In the latter case, the processor 160 communicates with the management server to acquire the necessary map information 191.

The surrounding situation information 192 is information indicating a situation around the vehicle 10. The processor 160 acquires the surrounding situation information 192 by using the recognition sensor. For example, the surrounding situation information 192 includes the image IMG captured by the camera 130. The surrounding situation information 192 further includes object information regarding an object around the vehicle 10. Examples of the object include a pedestrian, a bicycle, another vehicle (e.g., a preceding vehicle, a parked vehicle, etc.), a road configuration (e.g., a while line, a curb, a guard rail, a wall, a median strip, a roadside structure, etc.), a sign, an obstacle, and the like. The object information indicates a relative position and a relative velocity of the object with respect to the vehicle 10.

The vehicle state information 193 is information indicating the state of the vehicle 10. The processor 160 acquires the vehicle state information 193 from the vehicle state sensor.

The vehicle position information 194 is information indicating the position of the vehicle 10. The processor 160 acquires the vehicle position information 194 from a result of detection by the position sensor. In addition, the processor 160 may acquire highly accurate vehicle position information 194 by performing a well-known localization using the object information and the map information 191.

### 2-3. Vehicle Travel Control, Automated Driving Control

The processor 160 executes “vehicle travel control” that controls travel of the vehicle 10. The vehicle travel control includes steering control, acceleration control, and deceleration control. The processor 160 executes the vehicle travel control by controlling the travel device 140 (the steering device, the driving device, and the braking device). More specifically, the processor 160 executes the steering control by controlling the steering device. The processor 160 executes the acceleration control by controlling the driving device. The processor 160 executes the deceleration control by controlling the braking device.

In addition, the processor 160 executes the automated driving control based on the driving environment information 190. More specifically, the processor 160 sets a target route to a destination based on the map information 191 and the like. Then, the processor 160 performs the vehicle travel control based on the driving environment information 190 such that the vehicle 10 travels to the destination along the target route.

More specifically, the processor 160 generates a travel plan of the vehicle 10 based on the driving environment information 190. The travel plan includes maintaining a current travel lane, making a lane change, avoiding an obstacle, and so forth. Further, the processor 160 generates a target trajectory required for the vehicle 10 to travel in accordance with the travel plan. The target trajectory includes a target position and a target speed. Then, the processor 160 executes the vehicle travel control such that the vehicle 10 follows the target route and the target trajectory.

### 2-4. Processing Related to Remote Support

The processor 160 determines whether the remote support by the remote operator is necessary or not. Typically, a situation where the remote support by the remote operator is necessary is a situation where the automated driving is difficult. For example, when at least one of the above-described recognition process, action decision process, and timing decision process is difficult to perform, the processor 160 determines that the remote support by the remote operator is necessary.

When it is determined that the remote support is necessary, the processor 160 transmits the remote support request REQ to the remote support device 20 via the communication device 110. The remote support request REQ requires the remote operator to perform the remote support for the vehicle 10.

In addition, the processor 160 transmits the vehicle information VCL to the remote support device 20 via the communication device 110. The vehicle information VCL includes at least a part of the driving environment information 190. For example, the vehicle information VCL includes the image IMG captured by the camera 130. The vehicle information VCL may include the object information. The vehicle information VCL may include the vehicle state information 193 and the vehicle position information 194. The vehicle information VCL may include results of the recognition process, the action decision process, and the timing decision process.

Furthermore, the processor 160 receives the operator instruction INS from the remote support device 20 via the communication device 110. The operator instruction INS is an instruction to the vehicle 10 and is input by the remote operator. When receiving the operator instruction INS, the processor 160 performs the vehicle travel control in accordance with the received operator instruction INS.

### 3. Configuration Example of Remote Support Device

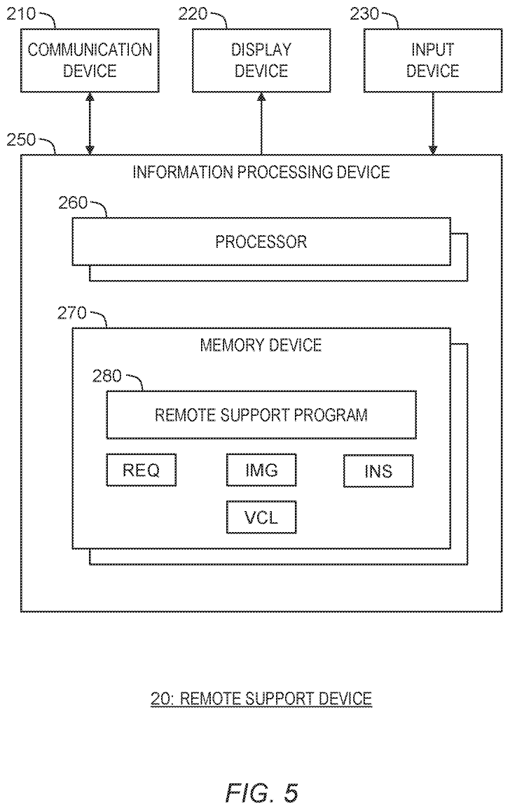

FIG. 5 is a block diagram showing a configuration example of the remote support device 20 according to the present embodiment. The remote support device 20 includes a communication device 210, a display device 220, an input device 230, and an information processing device 250.

The communication device 210 communicates with the outside. For example, the communication device 210 communicates with the vehicle 10 (the vehicle control system 100).

The display device 220 displays a variety of information. Examples of the display device 220 include a liquid crystal display, an organic EL display, a head-mounted display, a touch panel, and the like.

The input device 230 is an interface for accepting input from the remote operator. Examples of the input device 230 include a touch panel, a keyboard, a mouse, and the like.

The information processing device 250 executes a variety of information processing. The information processing device 250 includes one or more processors 260 (hereinafter simply referred to as a processor 260) and one or more memory devices 270 (hereinafter simply referred to as a memory device 270). The processor 260 executes a variety of processing. For example, the processor 260 includes a CPU. The memory device 270 stores a variety of information necessary for the processing by the processor 260. Examples of the memory 270 include a volatile memory, a non-volatile memory, an HDD, an SSD, and the like.

A remote support program 280 is a computer program for performing the remote support for the vehicle 10. The functions of the information processing device 250 are implemented by the processor 260 executing the remote support program 280 The remote support program is stored in the memory device 270. The remote support program 280 may be recorded on a non-transitory computer-readable recording medium.

The processor 260 communicates with the vehicle control system 100 via the communication device 210. For example, the processor 260 receives the remote support request REQ transmitted from the vehicle control system 100. The processor 260 notifies the remote operator of the remote support request REQ. In response to the remote support request REQ, the remote operator initiates the remote support for the vehicle 10.

In addition, the processor 260 receives the vehicle information VCL transmitted from the vehicle control system 100. The vehicle information VCL includes the image IMG that is captured by the camera 130. The processor 260 displays the vehicle information VCL on the display device 220.

The remote operator performs the remote support for the vehicle 10 by referring to the vehicle information VCL (especially the image IMG). More specifically, the remote operator inputs the operator instruction INS by using the input device 230. The processor 260 receives the operator instruction INS input through the input device 230. Then, the processor 260 transmits the operator instruction INS to the vehicle control system 100 via the communication device 210.

### 4. Split Image Transmission

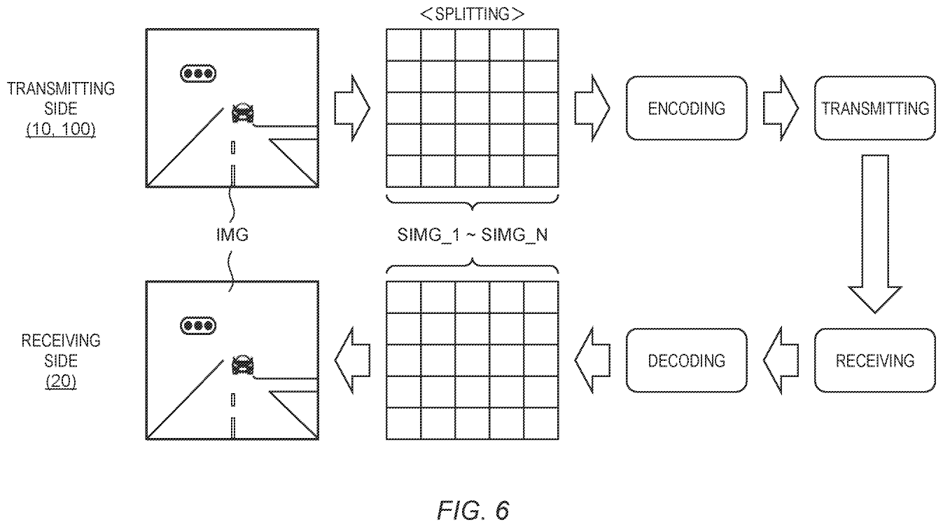

The vehicle remote support system 1 according to the present embodiment has a “split image transmission mode” in which the image IMG is split (divided) and transmitted from the vehicle 10 (vehicle control system 100) to the remote support device 20. FIG. 6 is a conceptual diagram for explaining an outline of the split image transmission mode according to the present embodiment.

The control device 150 the processor 160) of the vehicle control system 100 on the transmitting side acquires the image IMG captured by the camera 130 installed on the vehicle 10. The control device 150 spatially splits (divides) the image IMG of each frame into a plurality of split images SIMG_1 to SIMG_N (“image splitting process”). Here, N is an integer equal to or greater than 2. The control device 150 gives identification information to each split image SIMG_i (i=1 to N). The identification information includes a position of each split image SIMG_i in the original image IMG. Then, the control device 150 encodes and transmits each split image SIMG_i to the remote support device 20 (“split transmitting process”).

The information processing device 250 (i.e., the processor 260) of the remote support device 20 on the receiving side receives and decodes each split image SIMG_i. Then, the information processing device 250 displays (draws) each split image SIMG_i on the display device 220. At this time, the information processing device 250 grasps the position of each split image SIMG_i in the original image IMG based on the identification information included in each split image SIMG_i. Various examples can be considered as a method of displaying the received split images SIMG_i. For example, the information processing device 250 displays the received split images SIMG_i in sequence. As another example, the information processing device 250 may collectively display the split images SIMG_i of one frame. In other words, the information processing device 250 may combine the split images SIMG_i of one frame to restore the original image IMG, and then display the restored image IMG.

Adding a further twist to such the split image transmission brings a variety of advantages. For example, it is possible to reduce a data transmission amount. As another example, it is possible to reduce a delay of the image transmission. As features related to the split image transmission, “split image quality control” and “split image parallel processing” will be described below in detail.

### 5. Split Image Quality Control

### 5-1. Outline

The control device 150 (i.e., the processor 160) of the vehicle control system 100 can set respective image qualities of the plurality of split images SIMG_1 to SIMG_N separately. For example, the image quality can be changed by changing a compression ratio at the time of encoding. As another example, the image quality can be changed by changing a frame rate. The control device 150 sets the compression ratio or the frame rate separately for each split image SIMG_i.

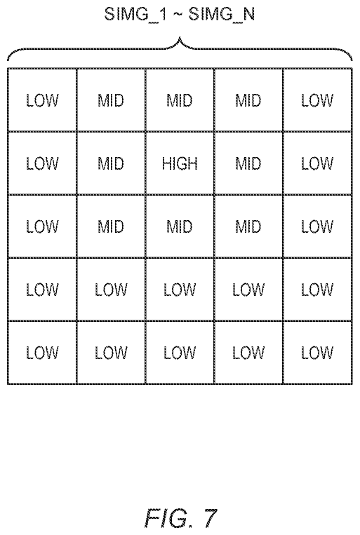

More specifically, the control device 150 sets “importance” of each of the plurality of split images SIMG_1 to SIMG_N. FIG. 7 shows an example of setting of the importance. In the example shown in FIG. 7, there are three levels of importance: “high,” “middle,” and “low.” Any of “high,” “middle,” and “low” is set as the importance for each split image SIMG_i. As another example, the importance may be quantified. The importance does not necessarily have to be set in stages. The importance may change continuously.

Typically, the control device 150 sets the importance of each split image SIMG_i in terms of “need for gaze by the remote operator.” That is, the control device 150 sets the importance of a split image SIMG_h with a higher need for gaze by the remote operator higher than the importance of another split image SIMG_l with a lower need for gaze by the remote operator (h and l are ones of numerals from 1 to N). Then, the control device 150 encodes and transmits each split image SIMG_i such that the image quality of the split image SIMG_h of the higher importance is higher than the image quality of the split image SIMG_l having the low importance.

As described above, according to the split image quality control, while the image quality of the split image split image SIMG_h of the higher importance is set higher, the image quality of the split image SIMG_l of the lower importance is set lower. It is thus possible to reduce a data transmission amount as a whole while securing the image quality of the important part. Since the data transmission amount is reduced, the delay of the image transmission is suppressed. That is, according to the present embodiment, it is possible to reduce the delay of the image transmission while securing the image quality of the important part. As a result, the accuracy of the remote support is improved. Furthermore, since the data transmission amount is reduced, a communication cost is also reduced.

### 5-2. Functional Configuration Example

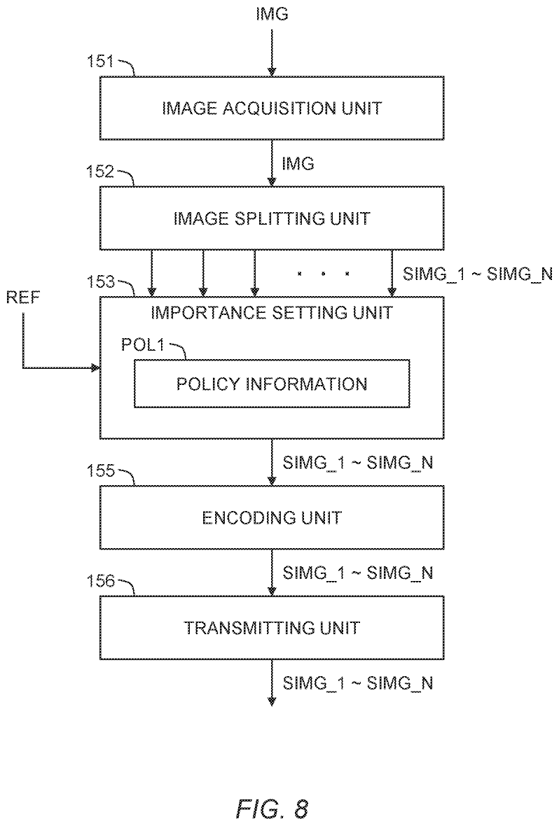

FIG. 8 is a block diagram showing an example of a functional configuration of the control device 150 related to the split image quality control. The control device 150 includes an image acquisition unit 151, an image splitting unit 152, an importance setting unit 153, an encoding unit 155, and a transmitting unit 156 as functional blocks. These functional blocks are implemented by the processor 160 executing the vehicle control program 180 and the memory device 170.

The image acquisition unit 151 acquires the image IMG captured by the camera 130 installed on the vehicle 10. The image IMG changes from moment to moment and changes in conjunction with movement of the vehicle 10 which is the target of the remote support.

The image splitting unit 152 executes the “image splitting process” that spatially splits the image IMG of each frame into the plurality of split images SIMG_1 to SIMG_N. Further, the image splitting unit 152 gives the identification information including the position in the original image IMG to each split image SIMG_i.

The importance setting unit 153 executes an “importance setting process” that sets the importance of each of the plurality of split images SIMG_1 to SIMG_N. Policy information POL1 indicates a setting policy of how the importance is set in what situation. Reference information REF is information indicating the situation. For example, the reference information REF indicates a dynamically-changing situation of the vehicle 10. It can be said that the policy information POL1 associates the content of the reference information REF with the importance of each split image SIMG_i. The policy information POL1 is generated in advance and stored in a memory device accessible by the importance setting unit 153. In accordance with the setting policy indicated by the policy information POLL the importance setting unit 153 sets the importance according to the situation indicated by the reference information REF. Various examples can be considered as to the reference information REF and the setting policy. That is, various examples can be considered as to the importance setting process. Various examples of the importance setting processing will be described in detail later.

The encoding unit 155 includes an encoder and encodes each of the plurality of split images SIMG_1 to SIMG_N. More specifically, the encoding unit 155 encodes each split image SIMG_i such that the image quality of the split image SIMG_h of the higher importance is higher than the image quality of the split image SIMG_l of the lower importance. For example, in a case of video compression algorithm such as H.264 and VP8, the image quality can be changed by changing a compression ratio at the time of encoding. For example, in the case of H.264, the image quality can be changed by changing a CRF (Constant Rate Factor).

The transmitting unit 156 transmits the plurality of split images SIMG_1 to SIMG_N after encoding to the remote support device 20. For example, the transmitting unit 156 includes a queue and transmits the plurality of split images SIMG_1 to SIMG_N in sequence.

### 5-3. Examples of Importance Setting Process

Various examples of the importance setting process will be described below. Typically, the importance setting unit 153 sets the importance of each split image SIMG_i in terms of “need for gaze by the remote operator.” That is, the importance setting unit 153 sets the importance of a split image SIMG_h with a higher need for gaze by the remote operator higher than the importance of another split image SIMG_l with a lower need for gaze by the remote operator.

### 5-3-1. First Example

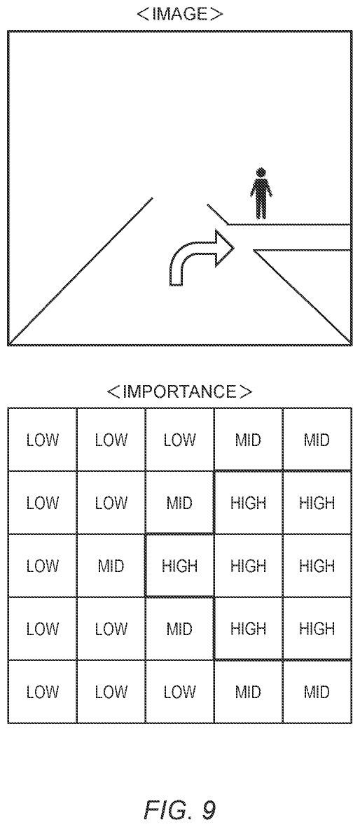

FIG. 9 is a conceptual diagram for explaining a first example of the importance setting process. In the first example, a planned movement direction of the vehicle 10 is taken into consideration. The planned movement direction of the vehicle 10 is important for the remote operator performing situation recognition.

The reference information REF is information reflecting the planned movement direction of the vehicle 10. For example, the reference information REF includes at least one of a steering direction of a steering wheel, a steering angle of the steeling wheel, and blinker information. Such the reference information REF can be obtained from the vehicle state information 193. As another example, the reference information REF may include a current position of the vehicle 10 and a target route. The current position of the vehicle 10 is obtained from the vehicle position information 194. The target route is determined and grasped by the control device 150.

The planned movement direction of the vehicle 10 dynamically changes. The importance setting unit 153 dynamically sets the importance of each split image SIMG_i based on the planned movement direction of the vehicle 10. More specifically, the importance setting unit 153 sets the importance of a split image SIMG_h is of a direction closer to the planned movement direction higher than the importance of a split image SIMG_l of a direction farther from the planned movement direction. This allows the remote operator to clearly recognize a situation in the planned movement direction of the vehicle 10.

In the example shown in FIG. 9, the vehicle 10 is scheduled to make a right turn or is in the middle of making a right turn, and the planned movement direction of the vehicle 10 is the right direction. In this case, a right center part of the image IMG is most important for the remote operator. Therefore, the importance of the split image SIMG in the right center part is set to be high.

### 5-3-2. Second Example

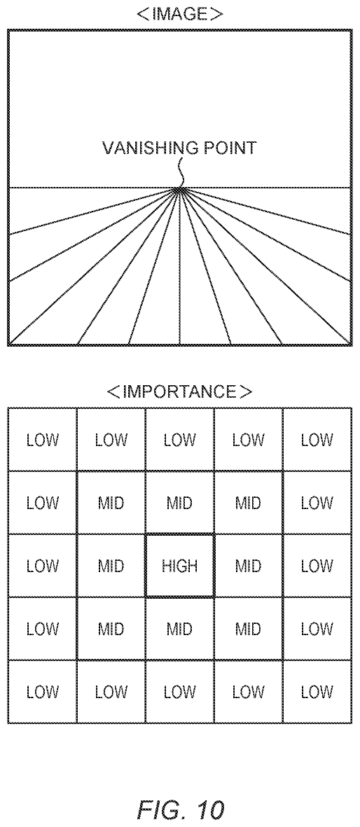

FIG. 10 is a conceptual diagram for explaining a second example of the importance setting process. In the second example, the reference information REF is setting information of the camera 130. The setting information of the camera 130 is beforehand stored in the memory device 270.

The importance setting unit 153 grasps a position of a vanishing point in the image IMG based on the setting information of the camera 130. Then, the importance setting unit 153 sets the importance of a split image SIMG_h of a direction closer to the vanishing point higher than the importance of a split image SIMG_l of a direction farther from the vanishing point. In other words, the importance setting unit 153 sets the importance of the split image SIMG_h of a direction closer to the vanishing point higher so that a distant portion can be seen more clearly. This allows the remote operator to clearly recognize the distant portion.

### 5-3-3. Third Example

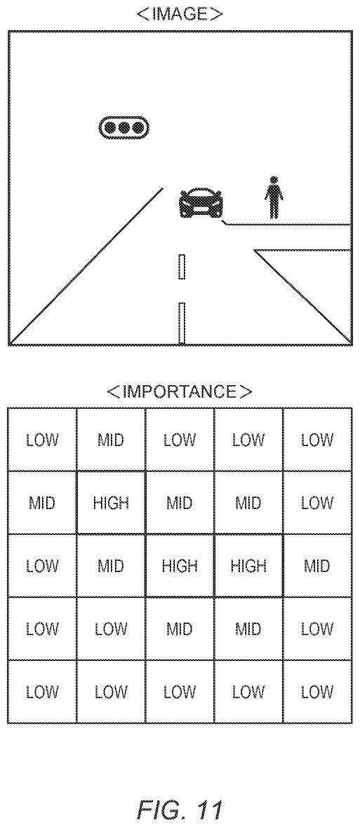

FIG. 11 is a conceptual diagram for explaining a third example of the importance setting process. In the third example, a “specific object” shown in the image IMG is taken into consideration. The specific object is an object that the remote operator is likely to gaze. For example, the specific object includes at least one of a pedestrian, a bicycle, another vehicle, a traffic light, and a sign.

The reference information REF indicates a position of the specific object in the image IMG. For example, the control device 150 (i.e., the processor 160) performs object recognition by analyzing the image IMG to acquire the reference information REF. The control device 150 provides the reference information REF to the importance setting unit 153.

The importance setting unit 153 sets the importance of a split image SIMG_h showing the specific object higher than the importance of a split image SIMG_l showing no specific object. The importance setting unit 153 may set the importance of a split image SIMG_h of a direction closer to the specific object higher than the importance of a split image SIMG_l of a direction farther from the specific object. In either case, the remote operator is able to clearly recognize the specific object.

### 5-3-4. Fourth Example

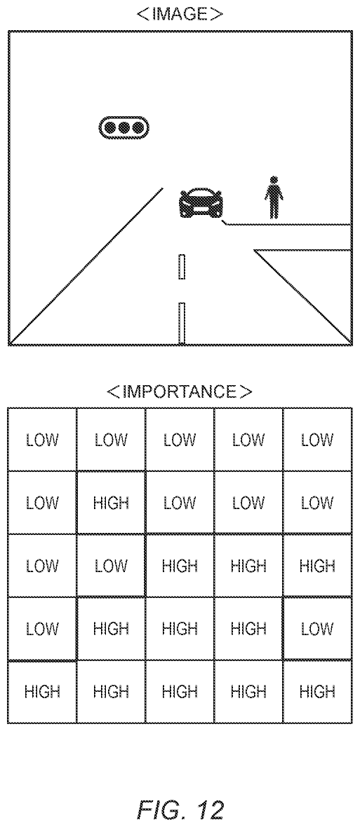

FIG. 12 is a conceptual diagram for explaining a fourth example of the importance setting process. In the fourth example, a segment of the image IMG in which a road or a target exists is taken into consideration. Examples of the target include a pedestrian, a bicycle, another vehicle, and the like. A segment of the image IMG in which a road or a target exists is hereinafter referred to as a “first segment.” On the other hand, a background segment other than the first segment is hereinafter referred to as a “second segment.”

The reference information REF indicates positions of the first segment and the second segment in the image IMG. For example, the control device 150 (i.e., the processor 160) divides the image IMG into the first segment and the second segment by applying a well-known segmentation to the image IMG, to acquire the reference information REF. The segmentation (domain division) is a technique for dividing the image into a plurality of segments by aggregating a group of portions having a similar feature amount (e.g., color, texture, etc.) in the image.

The importance setting unit 153 sets the importance of a split image SIMG_h of the first segment higher than the importance of a split image SIMG_l of the second segment (background region). This allows the remote operator to clearly recognize the first segment including the road or the target.

### 5-3-5. Fifth Example

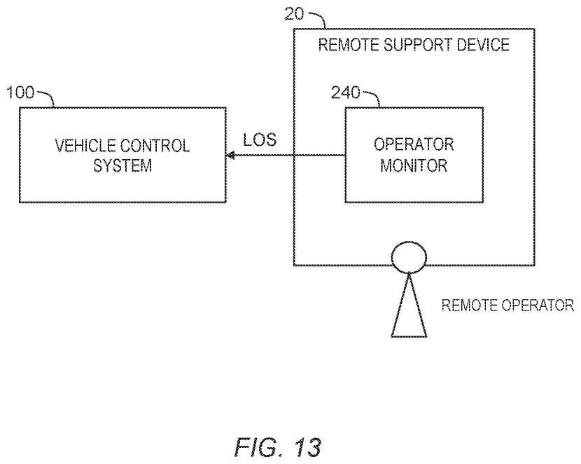

FIG. 13 is a block diagram for explaining a fifth example of the importance setting process. In the fifth example, an eye direction of the remote operator is taken into consideration.

The remote support device 20 is provided with an operator monitor 240 that detects the eye direction of the remote operator. The operator monitor 240 includes a camera for imaging eyes and a face of the remote operator. The operator monitor 240 detects the eye direction of the remote operator by analyzing an image of the remote operator captured by the camera. Then, the operator monitor 240 generates eye direction information LOS indicating the eye direction of the remote operator. The remote support device 20 transmits the eye direction information LOS to the vehicle control system 100. That is, the remote support device 20 feeds back the eye direction of the remote operator to the vehicle control system 100.

The reference information REF is the eye direction information LOS fed back from the remote support device 20. The eye direction of the remote operator changes dynamically. The importance setting unit 153 dynamically sets the importance of each split image SIMG_i based on the eye direction information LOS. More specifically, the importance setting unit 153 sets the importance of a split image SIMG_h of a direction closer to the eye direction higher than the importance of a split image SIMG_l of a direction farther from the eye direction. This allows the remote operator to clearly recognize a situation in the eye direction of the remote operator.

### 5-4. Effects

As described above, according to the present embodiment, the image IMG captured by the camera 130 installed on the vehicle 10 is split into the plurality of split images SIMG_1 to SIMG_N. Furthermore, the importance of each split image SIMG_i is set. Typically, the importance of the split image SIMG_h with a higher need for gaze by the remote operator is set to be higher than the importance of the split image SIMG_l with a lower need for gaze. Then, each split image SIMG_i is encoded and transmitted such that the image quality of the split image SIMG_h of the higher importance is higher than the image quality of the split image SIMG_l of the lower importance.

While the image quality of the split image split image SIMG_h of the higher importance is set higher, the image quality of the split image SIMG_l of the lower importance is set lower. It is thus possible to reduce a data transmission amount as a whole while securing the image quality of the important part. Since the data transmission amount is reduced, the delay of the image transmission is suppressed. That is, according to the present embodiment, it is possible to reduce the delay of the image transmission while securing the image quality of the important part. As a result, the accuracy of the remote support is improved. Furthermore, since the data transmission amount is reduced, a communication cost is also reduced.

### 6. Split Image Parallel Processing

### 6-1. Outline

As described above, the control device 150 (i.e., the processor 160) encodes and transmits each split image SIMG_i to the remote support device 20. The process of encoding and transmitting each split image SIMG_i to the remote support device 20 is hereinafter referred to as a “split transmitting process.” The control device 150 is able to execute the split transmitting processes for the plurality of split images SIMG_1 to SIMG_N partially in parallel. This processing is hereinafter referred to as “split image parallel processing.”

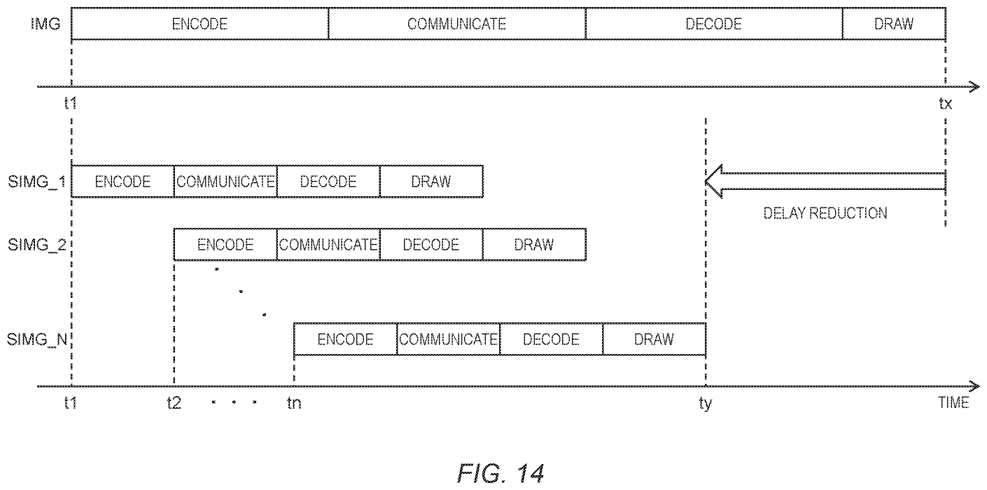

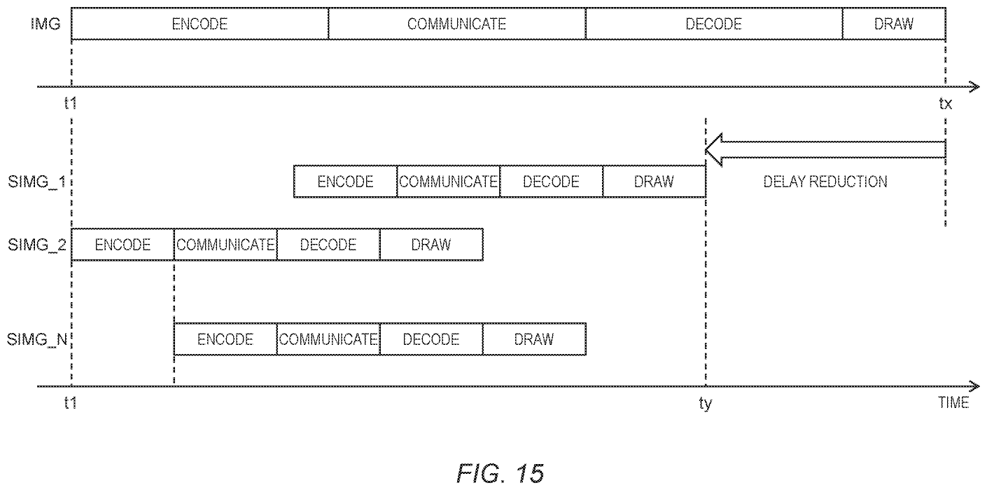

FIGS. 14 and 15 are timing charts for explaining examples of the split image parallel processing.

First, as a comparative example, a case where the split image parallel processing is not performed is considered. The case where the split image parallel processing is not performed is illustrated in an upper diagram in each of FIGS. 14 and 15. At a time t1, the transmitting side starts encoding the image IMG of a certain frame. After that, transmission of the image IMG from the transmitting side to the receiving side, decoding and drawing (displaying) of the image IMG on the receiving side are performed in sequence. At a time tx, the drawing of the image IMG of the frame on the receiving side is completed.

On the other hand, a case where the split image parallel processing is performed is as follows. In the case of the example shown in FIG. 14, at a time t1, the transmitting side starts encoding a split image SIMG_1. At a time t2, the encoding of the split image SIMG_1 is completed. After that, communication, decoding, and drawing of the split image SIMG_1 are performed in sequence. Upon completion of the encoding of the split image SIMG_1 at the time t2, the transmitting side can start encoding a next split image SIMG_2. That is to say, it is possible to encode the next split image SIMG_2 during a period when the communication of the split image SIMG_1 is in execution. The same applies to subsequent split images SIMG_i.

In this manner, the split transmitting processes for the plurality of split images SIMG_1 to SIMG_N are performed partially in parallel. Consequently, as shown in FIG. 14, the drawing of the image IMG for one frame is completed at a a time ty earlier than the time tx. That is, a time required for transmitting the entire image IMG is reduced. This means that a delay of the image transmission is reduced.

The processing order of the plurality of split images SIMG_1 to SIMG_N is not limited to that shown in FIG. 14. In the example shown in FIG. 15, the split image SIMG_2 is processed first, the split image SIMG_N is processed second, and the split image SIMG_1 is processed last. Even in this case, the delay of the image transmission is reduced.

According to the present embodiment, the control device 150 on the transmitting side sets “priorities” of the plurality of split images SIMG_1 to SIMG_N in accordance with a predetermined policy. Concrete examples of the predetermined policy will be described below. The control device 150 sequentially starts the split transmitting processes for the plurality of split images SIMG_1 to SIMG_N in an order of the set priorities. In addition, the control device 150 executes the split transmitting processes for the plurality of split images SIMG_1 to SIMG_N partially in parallel. As a result, the time required for transmitting the entire image IMG is reduced. That is, the delay of the image transmission is reduced. Since the delay of the image transmission is reduced, the accuracy of the remote support is improved.

It should be noted that when M communication lines are available (M is an integer equal to or greater than 2), M split images SIMG can be transmitted simultaneously in parallel. However, it is not always possible to use the same number of communication lines as the split number N of the image IMG. In many cases, the split number N of the image IMG is assumed to be larger than the number M of the available communication lines. In that case, it is necessary to transmit two or more split images SIMG via a single communication line. In such a case, the partially parallel processing according to the present embodiment is useful.

To generalize, the control device 150 executes the split transmitting processes for 2 or more split images of the plurality of split images SIMG_1 to SIMG_N partially in parallel. As a result, at least the delay reduction effect can be obtained.

### 6-2. Functional Configuration Example

### 6-2-1. Functional Configuration Example on Transmitting Side

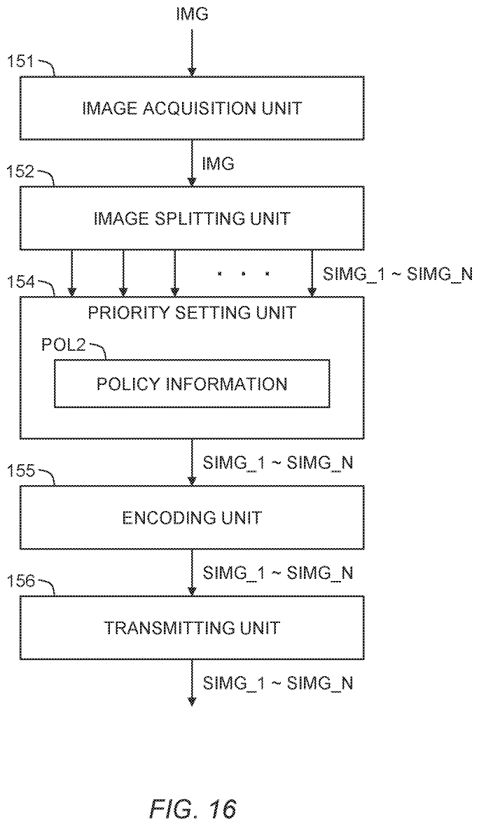

FIG. 16 is a block diagram showing an example of a functional configuration of the control device 1.50 related to the split image parallel processing. The control device 150 includes the image acquisition unit 151, the image splitting unit 152, a priority setting unit 154, the encoding unit 155, and the transmitting unit 156 as functional blocks. These functional blocks are implemented by the processor 160 executing the vehicle control program 180 and the memory device 170.

The image acquisition unit 151, the image splitting unit 152, the encoding unit 155, and the transmitting unit 156 are the same as those described in the above Section 5.

The priority setting unit 154 performs a “priority setting process” that sets the priorities of the plurality of split images SIMG_1 to SIMG_N. Policy information POL2 is information indicating a setting policy of how the priorities are set. The policy information POL2 is generated in advance and stored in a memory device accessible by the priority setting unit 154. In accordance with the setting policy indicated by the policy information POL2, the priority setting unit 154 sets the priorities of the plurality of split images SIMG_1 to SIMG_N. Various examples can be considered as to the priority setting process. Various examples of the priority setting process will be described in detail later.

The priority setting unit 154 sequentially outputs the plurality of split images SIMG_1 to SIMG_N to the encoding unit 155 in the order of the set priorities. Alternatively, the priority setting unit 154 provides the encoding unit 155 with the priorities together with the plurality of split images SIMG_1 to SIMG_N. The encoding unit 155 stores the plurality of split images SIMG_1 to SIMG_N in a buffer and sequentially encodes the plurality of split images SIMG_1 to SIMG_N in the order of the priorities.

### 6-2-2. Functional Configuration Example on Receiving Side

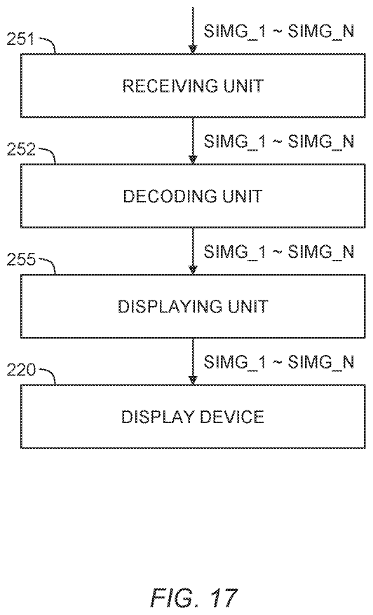

FIG. 17 is a block diagram showing an example of a functional configuration of the information processing device 250 of the remote support device 20 on the receiving side. The information processing device 250 includes a receiving unit 251, a decoding unit 252, and a displaying unit 255 as functional blocks. These functional blocks are implemented by the processor 260 executing the remote support program 280 and the memory device 270.

The receiving unit 251 sequentially receives the plurality of split images SIMG_1 to SIMG_N transmitted from the vehicle control system 100.

The decoding unit 252 includes a decoder and decodes each of the plurality of split images SIMG_1 to SIMG_N. The decoding unit 252 decodes the plurality of split images SIMG_1 to SIMG_N in an order of reception.

The displaying unit 255 displays (draws) each split image SIMG_i on the display device 220. At this time, the displaying unit 255 grasps the position of each split image SIMG_i in the original image IMG based on the identification information included in each split image SIMG_i. For example, the displaying unit 255 receives the split images SIMG_i sequentially output from the decoding unit 252, and sequentially displays the received split images SIMG_i. In other words, the displaying unit 255 displays the plurality of split images SIMG_1 to SIMG_N in the order of arrival at the remote support device 20.

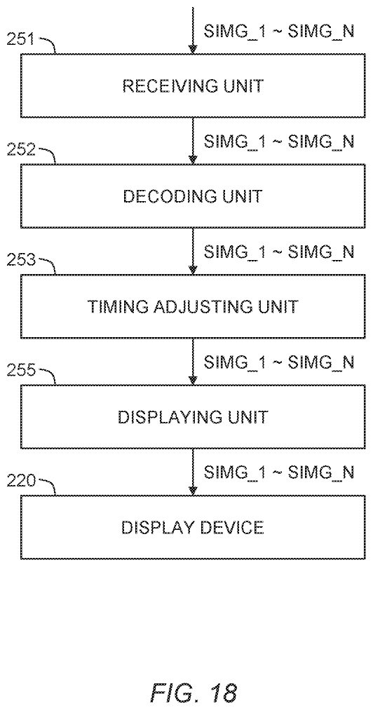

FIG. 18 is a block diagram showing another example of the functional configuration on the receiving side. In the example shown in FIG. 18, the information processing device 250 further includes a timing adjusting unit 253. The timing adjusting unit 253 is provided for suppressing a difference in a display timing between the split images SIMG_1 to SIMG_N. The timing adjusting unit 253 is provided between the decoding unit 252 and the displaying unit 255.

The timing adjusting unit 253 receives the split images SIMG sequentially output from the decoding unit 252. When receiving a split image SIMG_j, the timing adjusting unit 253 monitors a delay between the split image SIMG_j and a subsequent split image SIMG_k. The timing adjusting unit 253 waits an output of the split image SIMG_j so that the delay falls within an allowable range. When the delay of the subsequent is within the allowable range, the timing adjusting unit 253 outputs the split image SIMG_j to the displaying unit 255. This suppresses the difference in the display timing between the split images SIMG_1 to SIMG_N.

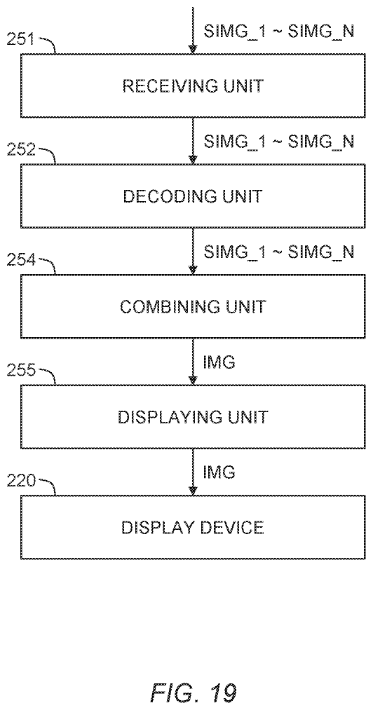

FIG. 19 is a block diagram showing still another example of the functional configuration on the receiving side. In the example shown in FIG. 19, the information processing device 250 further includes a combining unit 254. The combining unit 254 is provided between the decoding unit 252 and the displaying unit 255.

The combining unit 254 stores the split images SIMG_1 to SIMG_N sequentially output from the decoding unit 252 in a buffer. The combining unit 254 combines the split images SIMG_1 to SIMG_N of one frame to restore the original image IMG. At this time, the combining unit 254 grasps the position of each split image SIMG_i in the original image IMG based on the identification information included in each split image SIMG_i. Then, the combining unit 254 outputs the restored image IMG to the displaying unit 255. It is thus possible to eliminate the difference in the display timing. However, a display timing of the split images SIMG_1 to SIMG_N as a whole becomes slower than that in the cases of the examples shown in FIGS. 17 and 18.

### 6-3. Examples of Priority Setting Process

Various examples of the priority setting process will be described below.

### 6-3-1. First Example

In a first example, the priority is in the order of “importance” described in the above Section 5. In this case, the priority setting unit 154 has the same function as the importance setting unit 153 described in Section 5, and sets the importance of each of the plurality of split images SIMG_1 to SIMG_N. Then, the priority setting unit 154 sets the priorities of the plurality of split images SIMG_1 to SIMG_N such that the priority is higher as the importance is higher. In the case of the first example, it is preferable to display the plurality of split images SIMG_1 to SIMG_N in the order of earliest without combining them. Since the split image SIMG of the higher importance is displayed earlier, the accuracy of the remote support is further improved.

### 6-3-2. Second Example

In a second example, the priority is set from a viewpoint of a data amount of each split image SIMG_i. More specifically, the priority setting unit 154 sets the priorities of the plurality of split images SIMG_1 to SIMG_N such that the priority is higher as the data amount is larger.

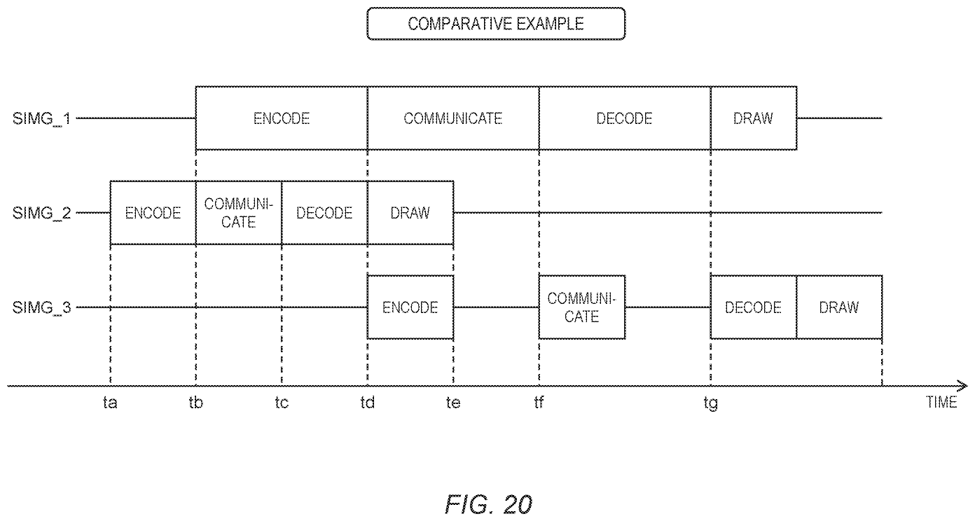

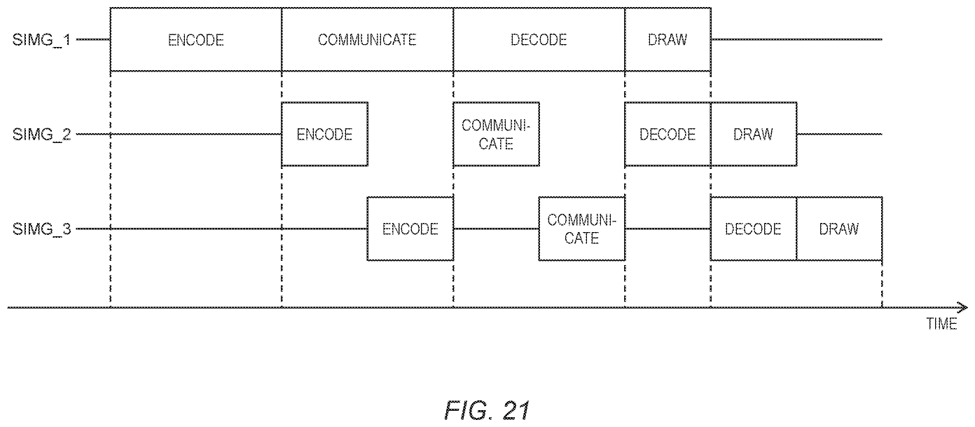

An effect of the second example of the priority setting process will be described with reference to FIGS. 20 and 21. Here, for simplicity, three split images SIMG_1 to SIMG_3 are considered. The data amount of the split image SIMG_1 is larger than the data amounts of the other split images SIMG_2 and SIMG_3.

In the example shown in FIG. 20, the split image SIMG_2 is processed first, the split image SIMG_1 is processed second, and the split image SIMG_3 is processed last. As to the split image SIMG_2, the encoding is performed in a period from a time ta to a time tb, the communication is performed in a period from the time tb to a time tc, the decoding is performed in a period from the time tc to a time td, and the drawing is performed in a period from the time td to a time te. As to the subsequent split image SIMG_1, the encoding is performed in a period from the time tb to the time td, the communication is performed in a period from the time td to a time tf, the decoding is performed in a period from the time tf to a time tg, and the drawing is performed after the time tg. As a result, regarding the communication, a vacant time occurs in a period between the time tc and the time td. Regarding the decoding, a vacant time occurs in a period between the time td and the time tf. Regarding the drawing, a vacant time occurs in a period between the time te and the time tg. Such the vacant times are wasteful and inefficient. In addition, a large gap between the drawing timing of the split image SIMG_2 and the drawing timing of the subsequent split image SIMG_1 is not desirable from a viewpoint of visibility.

On the other hand, in the example shown in FIG. 21, the priority is set to he higher as the data amount is larger. That is, the priority of the split image SIMG_1 with the largest data amount is set to the highest. As a result, each of the encoding, the communication, the decoding, and the drawing is performed efficiently without a vacant time. Therefore, the transmission time of the image IMG of one frame is minimized. Furthermore, the gap in the drawing timing is eliminated.

### 6-4. Other Examples

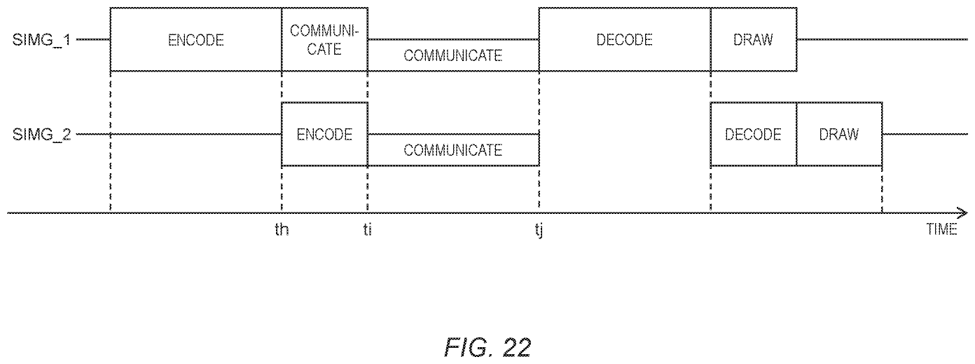

A bands of a single communication line may be shared by two or more split images SIMG. For instance, FIG. 22 shows an example of band sharing by the split images SIMG_1 and SIMG_2. At a time th, the communication of the split image SIMG_1 starts. In a period from the time th to a time ti, the encoding of the subsequent split image SIMG_2 is performed. At the time ti, the communication of the split image SIMG_2 starts. In a period between the time ti and a time tj, the band of a single communication line is shared by the split images SIMG_1 and SIMG_2. More specifically, the control device 150 mixes and transmits packets of the split images SIMG_1 and SIMG_2.

### 6-5. Effects

As described above, according to the present embodiment, the image IMG captured by the camera 130 installed on the vehicle 10 is split into the plurality of split images SIMG_1 to SIMG_N. Furthermore, the priorities of the plurality of split images SIMG_1 to SIMG_N are set in accordance with a predetermined policy. Then, the split transmitting processes for two or more split images SIMG are sequentially started in the order of the set priorities. Furthermore, the split transmitting processes for the two or more split images SIMG are executed partially in parallel. As a result, the time required for transmitting the entire image IMG is reduced. That is, the delay of the image transmission is reduced. Since the delay of the image transmission is reduced, the accuracy of the remote support is improved.

### 7. Combination of Split Image Quality Control and Split Image Parallel Processing

It is also possible to perform both the “split image quality control” described in Section 5 and the “split image parallel processing” described in Section 6.

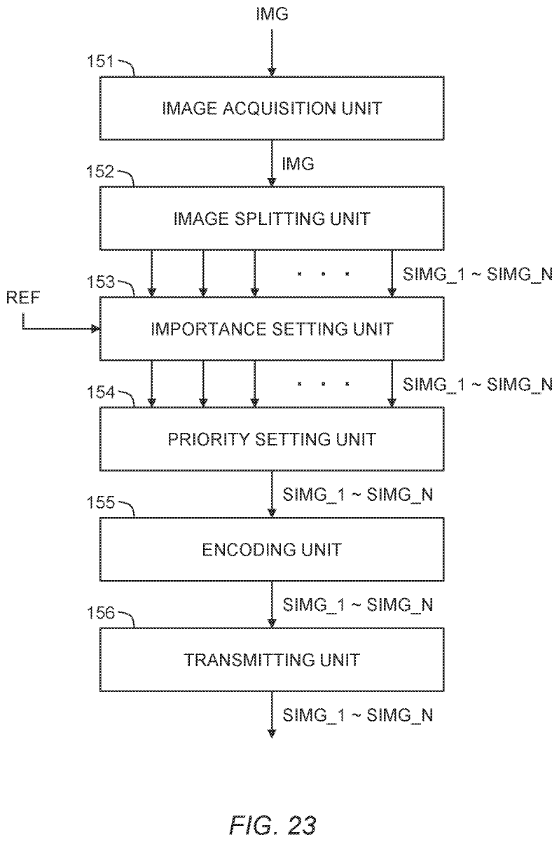

FIG. 23 is a block diagram showing still another example of the functional configuration of the control device 150 on the transmitting side. The control device 150 includes the image acquisition unit 151, the image splitting unit 152, the importance setting unit 153, the priority setting unit 154, the encoding unit 155, and the transmitting unit 156 as functional blocks. The importance setting unit 153 sets the importance of each of the plurality of split images SIMG_1 to SIMG_N. The priority setting unit 154 sets the priorities of the plurality of split images SIMG_1 to SIMG_N. The encoding unit 155 encodes the plurality of split images SIMG_1 to SIMG_N in the order of priorities. At this time, the encoding unit 155 encodes each split image SIMG_i such that the image quality of the split image SIMG_h of the high importance is higher than the image quality of the split image SIMG_l of the lower importance.

As a result, the effects of both of the “split image quality control” described in Section 5 and the “split image parallel processing” described in Section 6 can be obtained.

What is claimed is:

1. A moving body control system that controls a moving body being a target of remote support by a remote operator,
the moving body control system comprising:
one or more processors configured to:
acquire an image captured by a camera installed on the moving body and indicating a situation around the moving body;
execute an image splitting process that spatially splits the image into a plurality of split images;
execute an importance setting process that sets importance of each of the plurality of split images such that the importance of a split image with a higher need for gaze by the remote operator is higher than the importance of a split image with a lower need for the gaze by the remote operator; and
execute a split transmitting process that encodes and transmits each of the plurality of split images to a remote support device on a side of the remote operator such that an image quality of the split image of the higher importance is higher than an image quality of the split image of the lower importance.

2. The moving body control system according to claim 1, wherein
in the importance setting process, the one or more processors are further configured to:
acquire information reflecting a planned movement direction of the moving body; and
set the importance of each of the plurality of split images based on the planned movement direction of the moving body.

3. The moving body control system according to claim 2, wherein
the one or more processors are further configured to set the importance of a split image of a direction closer to the planned movement direction higher than the importance of a split image of a direction farther from the planned movement direction.

4. The moving body control system according to claim 1, wherein
in the importance setting process, the one or more processors are further configured to set the importance of a split image of a direction closer to a vanishing point in the image higher than the importance of a split image of a direction farther from the vanishing point.

5. The moving body control system according to claim 1, wherein
a specific object includes at least one of a pedestrian, a bicycle, another vehicle, a traffic light, and a sign, and
in the importance setting process, the one or more processors are further configured to:
acquire information indicating a position of the specific object in the image; and
set the importance of a split image showing the specific object higher than the importance of a split image showing no specific object.

6. The moving body control system according to claim 1, wherein
a first segment is a segment of the image in which a road or a target exists, and
in the importance setting process, the one or more processors are further configured to:
acquire information indicating a position of the first segment in the image; and
set the importance of a split image of the first segment higher than the importance of a split image of a second segment other than the first segment.

7. The moving body control system according to claim 1, wherein
the one or more processors are further configured to:
set priorities of the plurality of split images such that a priority is higher as the importance is higher; and
start the split transmitting process for the plurality of split images in an order of the priorities and execute the split transmitting process for the plurality of split images partially in parallel.

8. A moving body control method that controls a moving body being a target of remote support by a remote operator,
the moving body control method comprising:
acquiring an image captured by a camera installed on the moving body and indicating a situation around the moving body;
an image splitting process that spatially splits the image into a plurality of split images;
an importance setting process that sets importance of each of the plurality of split images such that the importance of a split image with a higher need for gaze by the remote operator is higher than the importance of a split image with a lower need for the gaze by the remote operator; and
a split transmitting process that encodes and transmits each of the plurality of split images to a remote support device on a side of the remote operator such that an image quality of the split image of the higher importance is higher than an image quality of the split image of the lower importance.

9. A moving body remote support system comprising:
a moving body being a target of remote support by a remote operator; and
a remote support device on a side of the remote operator, wherein
the moving body is configured to:
acquire an image captured by a camera installed on the moving body and indicating a situation around the moving body;
execute an image splitting process that spatially splits the image into a plurality of split images;
execute an importance setting process that sets importance of each of the plurality of split images such that the importance of a split image with a higher need for gaze by the remote operator is higher than the importance of a split image with a lower need for the gaze by the remote operator; and
execute a split transmitting process that encodes and transmits each of the plurality of split images to the remote support device such that an image quality of the split image of the higher importance is higher than an image quality of the split image of the lower importance.

10. The moving body remote support system according to claim 9, wherein
the remote support device is configured to:
receive the plurality of split images from the moving body; and
decode and display each of the plurality of split images on a display device.
